(19) United States
(12) Patent Application Publication
(10) Pub. No.: US 2009/0027728 A1
(43) Pub. Date: Jan. 29, 2009

(54) IMPOSITION OF DOCUMENTS WITH VARIABLE PROPERTIES

(76) Inventor: Boris Aronshtam, San Carlos, CA (US)

Correspondence Address: David A. Novais;Patent Legal Staff, Eastman Kodak Company, 343 State Street, Rochester, NY, 14650-2201, US

(21) Appl. No.: 11/781,283

(22) Filed: Jul. 23, 2007

(51) Int. Cl. G06F 15/00

(52) U.S. Cl. 358/1.18

(57) ABSTRACT

A method and apparatus for optimal imposition of documents with variable properties (61, 62) is provided. The method and apparatus rearranges documents by combining documents with the same properties together. The documents with the same or similar properties are imposed side-by-side, saving paper and enabling finishing that otherwise is impossible, undesirable, or non-economical.

### FIELD OF THE INVENTION

The present invention relates to methods and apparatus for imposing pages of multiple documents on large sheets as required by printers and printing presses for efficient printing and saving on printer costs.

### BACKGROUND OF THE INVENTION

The invention deals with imposing multiple documents side-by-side. A typical use of such multi-document imposition is imposition of variable data printing (VDP) jobs. Another term for variable data printing is personalized printing.

A VDP job consists of multiple personal documents. Each document is intended to be received by one recipient (person, organization, etc.). There are a number of VDP languages. The most known are PPML, VDX, Creo VPS, Xerox VIPP, and IBM AFP/IPDS. Often non-VDP languages are used to express multi-document jobs, such as Adobe PostScript, Adobe PDF, and Microsoft XPS. In some cases multiple separate personalized jobs are combined together to form a larger job, which is similar to a VDP job. These separate personalized jobs can be considered as documents.

It is common to combine documents together and print them side-by-side. This is a known practice of efficient and economical printing of documents on large media. For example, if media width is 17″ and each document width is 8″, two documents can be printed side-by-side as shown in FIG. 1. The figure shows a VDP job that contains 1,000 documents.

FIG. 2 illustrates cut-and-stack imposition, another typical imposition scheme for multi-document jobs. The advantage of the cut and stack imposition is that after cutting the sheets into two halves, left side 21 and right side 22, left side 21 is stacked on top of right side 22 to form a perfect sequential order.

The above two imposition schemes work well when all the documents in the job have the same number of pages, i.e. equal-size documents. The documents are therefore properly aligned and can be finished appropriately.

However, VDP jobs that contain non-equal size documents are typical. When printing such documents side-by-side, the existing systems may provide two methods, printing documents unaligned (FIG. 3), or inserting empty slots to align the documents (FIG. 4). Both methods have problems.

The unaligned 2-up imposition method shown in FIG. 3 complicates finishing or makes finishing impossible. Suppose first and last pages of the document need to be printed using cover-stock, hard paper, while other pages in each document need to be printed on regular paper. Obviously unaligned 2-up scheme are not suitable for this finishing.

The aligned 2-up imposition method shown in FIG. 4 requires insertion of empty slots 41. These slots result in empty pages. Consider a mobile phone statement where each document contains between 2 and 50 pages. Obviously it is unacceptable for the recipients to receive statements containing up to 48 empty pages. Moreover, removing empty pages is sometimes not a viable option because of finishing considerations. Trying to remove empty pages will result in discarding back-covers for approximately half of the documents. Keeping back-covers may also not be an option since the back-cover content is defined on the last non-empty page in each document.

Another variable property of a document in a VDP job is media-type. For example, some document covers are specified to be printed on yellow paper, while some other document covers are specified to be printed on pink paper. Trying to impose such documents side-by-side using the above conventional imposition methods makes printing impossible.

The existing imposition applications used in the realm of digital front ends (DFEs) do not address the issue described above. Therefore there is a need for a method which eliminates or significantly reduces the number of empty pages, as well as allows required finishing. The current invention satisfies these needs and thus overcomes the problems specified above.

### SUMMARY OF THE INVENTION

Briefly, according to one aspect of the present invention a method for imposing a variable data printing (VDP) job comprises examining a plurality of documents for the VDP job for document properties; sorting the documents by the document properties; and printing the plurality of documents having the same or similar properties side-by-side on a printing media.

### BRIEF DESCRIPTION OF THE DRAWINGS

FIG. 1 is a schematic illustrating a 2-up imposition.

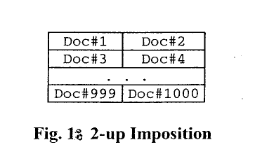

FIG. 2 is a schematic illustrating a cut and stack imposition.

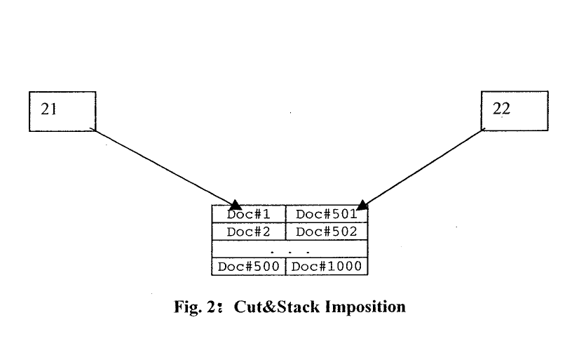

FIG. 3 is a schematic illustrating an un aligned 2-up imposition.

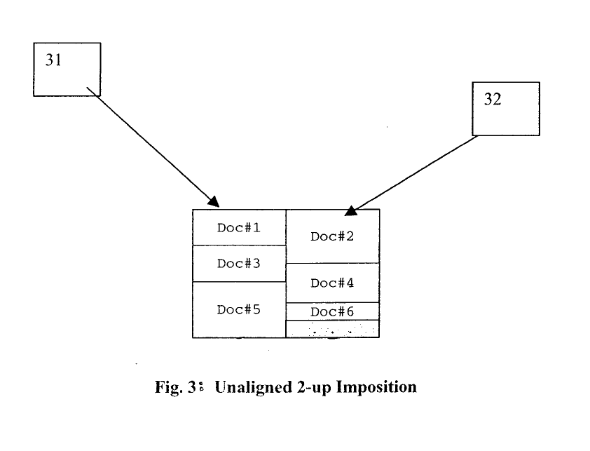

FIG. 4 is a schematic illustrating an aligned 2-up imposition.

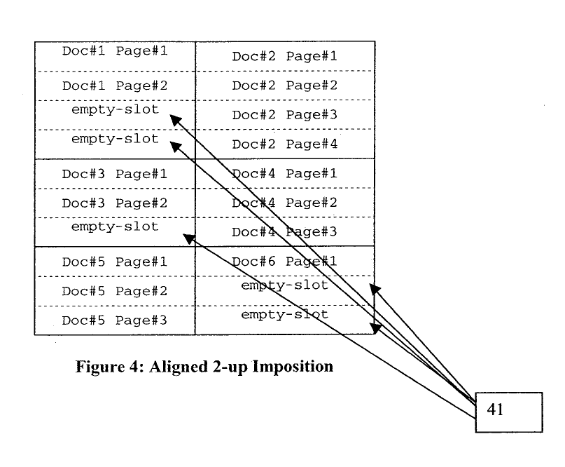

FIG. 5 is a table illustrating document sizes distribution.

FIG. 6 is a schematic illustrating an optimized two up imposition.

### DETAILED DESCRIPTION OF THE INVENTION

Documents in a VDP job typically have similar sizes. For example, usually credit card printed statements will include between 2 and 5 pages. Mobile phone printed statements will include between 2 and 50 pages. Personalized printed phone books, might vary between 500-1,000 pages, per each phone book.

The number of documents in a typical VDP job is large. A VDP job can contain as many as 100,000 or even 1,000,000 documents. Each finished document is typically uniquely identifiable for the purposes of appropriate delivery.

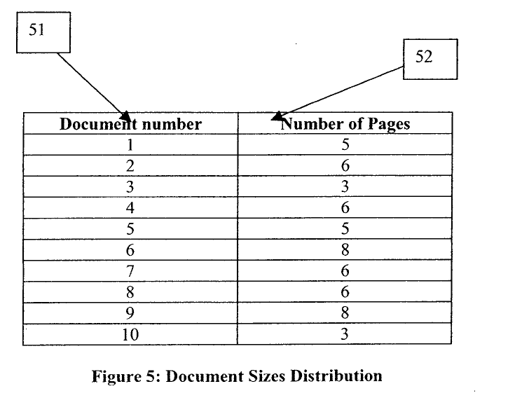

The above observations allow performing a very important operation, rearranging the documents according to document sizes and other important variable properties. The invention is best understood by referring to the table in FIG. 5 that shows the first 10 documents. The documents in the table are ordered sequentially. Each row in the table contains the number of the document in column 51 and the number of pages in the document in column 52.

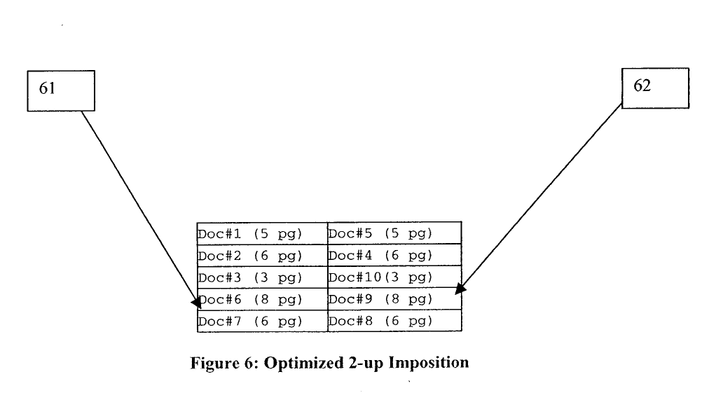

Using a conventional 2-up imposition would result in a large number of empty pages. But by rearranging documents according to the present invention, nearly all the empty pages are eliminated. This is shown in FIG. 6 wherein the documents on the left side 61 contain the same number of pages as documents on the right side 62.

Some additional explanation will assist in a deeper understanding of the invention and the invention ramifications. When printing a large VDP job the document sizes will not align as perfectly as shown in FIG. 6. There will be some documents that will not contain matching documents of the same size. In this case the system may invoke either of the following methods.

The first method, method A, will require leaving the right or left half of the sheet empty for such documents. Though this will result in a number of empty pages, the ratio of empty pages to a total number of pages in the large VDP job will be small. The main advantage of this approach is that it allows required finishing (e.g. using cover-stock for cover pages) that the conventional imposition methods do not allow.

The second method, method B, can be used in cases wherein finishing is not required. In this method the remaining documents will be arranged together, according to their sizes, and printed side-by-side. Though this still will result in a number of empty pages, the ratio of empty pages to a total number of pages in the large VDP job will be small, virtually negligible for all the practical considerations.

When processing or streaming a large VDP job there could be a limitation on a number of documents that can be kept in the available storage: for example, 100 documents. In an extremely rare case when the system accumulates 100 documents of different sizes, the techniques described in the method A and B above, can be applied to reduce or to flush the documents from the storage.

The approach is obviously not limited to 2-up imposition. It can be used with 3-up, 2×2-up and any other imposition. Moreover, the approach is not limited to the case wherein each column contains 1 page. Each column can represent a complex imposition of one document, e.g. 16-page cross-folded imposition.

The example shows the optimization needed to adjust for variable document-sizes. Though this is probably the most important need, other optimizations sometimes are needed. The invention includes all such optimization. For example, there could be a requirement that some document covers are to be printed on pink-media, while some other document covers are to be printed on yellow-media. In this case an embodiment of the invention in addition to sorting the documents according the document size, will sort the documents according to required media.

The invention can be used with other techniques that sort the documents according some other properties. For example, if the documents are pre-sorted according to zip-code, the invention will preserve groups of documents having the same zip-code, while sorting and optimizing according to finishing parameters and document-sizes.

Yet another aspect of the invention deals with the situation wherein the original order of documents is important. In this case an embodiment of the invention rearranges pages as described above, then process orders the document to follow the original order. If needed, the optimized imposition may assist such ordering process by printing identification marks, e.g. document numbers, barcodes, magnetic ink, etc. In one approach the document identification marks can be printed in the margin-area of the sheet (as opposed to within the page-area). In this case the final cutting of the documents that removes the margins happens after the documents are ordered according to the original order.

The invention has been described in detail with particular reference to certain preferred embodiments thereof, but it will be understood that variations and modifications can be effected within the scope of the invention.

### PARTS LIST

21 left side stack

22 right side stack

41 empty slots

51 document number

52 number of pages

61 documents on the left side

62 documents on the right side

1. A method for imposing a variable data printing (VDP) job comprising:
examining a plurality of documents for said VDP job for document properties;
sorting said documents by said document properties; and
printing said plurality of documents having the same or similar properties side-by-side on a printing media.

2. The method of claim 1 wherein said document property is number of pages in a document.

3. The method of claim 1 wherein said document property is media-type to be used for an entire document or the parts of a document.

4. A method for imposing a variable data printing (VDP) job comprising:
examining said VDP job for a first output property for a plurality of VDP documents to be produced from said VDP job;
sorting said VDP documents by said first output property; and
printing said plurality of said VDP documents having similar output properties on a printing media.

5. The method of claim 4 wherein the first output property is number of pages.

6. The method of claim 4 wherein the first output property is media-type to be used for parts of the VDP document.

7. The method of claim 6 wherein:
a second output property of the VDP document is number of pages; and
sorting said VDP documents by said second property performed prior to printing.

8. The method of claim 4 comprising:
sorting said VDP document a second time for a second output property prior to printing.

9. A method for imposing variable data printing (VDP) comprising:
examining the VDP job for a first output property for a plurality of VDP documents;
sorting the VDP documents by the first output property;
examining the VDP job for a second output property for the plurality of VDP documents;
sorting the VDP documents for a second property; and
printing the VDP documents having similar first and second properties on a printing media such that documents having similar properties are aligned.
